(19) United States
(12) Patent Application Publication
(10) Pub. No.: US 2005/0041307 A1
(43) Pub. Date: Feb. 24, 2005

(54) Directed Fresnel lenses

(76) Inventor: Stephen Barone, Dix Hills, NY (US)

Correspondence Address: Carter, DeLuca, Farrell & Schmidt, LLP, Suite 225, 445 Broad Hollow Road, Melville, NY, 11784, US

(21) Appl. No.: 10/896,406

(22) Filed: Jul. 22, 2004

Related U.S. Application Data
(60) Provisional application No. 60/489,566, filed on Jul. 22, 2003.

(51) Int. Cl. G02B 3/08

(52) U.S. Cl. 359/742

(57) ABSTRACT

Directed Fresnel lenses provide an angular field of view centered on any direction.

### RELATED APPLICATIONS

This application claims priority to U.S. Provisional Application Ser. No. 60/489,566 filed Jul. 22, 2003, the entire disclosure of which is incorporated herein by this reference.

### BACKGROUND

1. Technical Field

This disclosure relates to a new type of Fresnel lens, namely a directed Fresnel lens.

2. Description of the Related Art

The concept of a Fresnel lens is illustrated in FIG. 1 for the special case of a plano-convex lens with incident radiation from the convex side of the lens. The upper surface 11 (shown in phantom) of a plano-convex lens is designed so that a ray 12 parallel to the optic axis 13 of the system is refracted at the upper surface 11 so that upon a second refraction at the lower, planar surface 14 the emerging ray passes through the lower focal point 15. The corresponding Fresnel lens replaces the upper refracting surface 11 by the surface 16 which, in sections, approximately replicates the upper surface 11. The original lens is divided into segments by the vertical lines 17. In a system with rotational symmetry the lines 17 represent a system of concentric cylinders, or concentric circles in the plane 14. In a system with cylindrical symmetry the lines 17 represent a system of parallel planes or parallel lines in the plane 14. The curvature of each segment of the surface 11 between two of the lines 17, is translated downwards towards the plane 14 with a modification of the curvature of each of the segments 16 to compensate for the displacement of the segment from its original position on the lens surface 11. The new, Fresnel lens is smaller, weighs less, and has less loss than the original lens but has approximately the same imaging behavior as the original lens in the near forward direction. As the direction of the incident ray 12 moves away from that of the optic axis 13 of the system, a variety of aberrations limit the angular range over which the Fresnel lens behaves as an “ideal” lens.

### SUMMARY

A new type of Fresnel lens which has an angular field of view which is not centered on the direction perpendicular to the lens is described herein. This new type of lens, referred to herein as a “directed Fresnel lens”, has a field of view which can be centered on a non-vanishing angle of incidence.

As noted above, the angular field of view of a conventional Fresnel lens is centered on the forward direction and limited. If there is a need to cover wider angles the lens can be mechanically rotated. For each specific angle of rotation the lens retains the same angular field of view centered on the optic axis of the rotated lens. Alternatively, one lens can be supplemented with additional lenses each of which has a limited field of view which is centered on a different, rotated, optic axis. In this way a wider range of angles can be covered with a number of lenses each of which has a limited field of view and a different optic axis. The directed Fresnel lenses of the novel structure described herein are a modification of the conventional Fresnel lens which has approximately the same field of view as the conventional Fresnel lens, but the field of view is centered on a direction which is not perpendicular to the lens.

Thus, lenses in accordance with this disclosure include a surface having plurality of grooves, with each groove having at least one substantially straight side and a possibly curved bottom. In one embodiment, the lens also includes a second flat surface, and the side wall of at least one groove is not perpendicular to the second flat surface. In another embodiment, the straight sides of at least two of the plurality of grooves are not parallel to each other. In yet other embodiments, a lens array including one or more directed Fresnel lenses in accordance with this disclosure is contemplated.

### BRIEF DESCRIPTION OF THE DRAWINGS

The features and performance of the new type of Fresnel lens described herein will become more readily apparent and may be better understood by referring to the following detailed descriptions of illustrative embodiments, taken in conjunction with the accompanying drawings, in which:

FIG. 1 is a schematic drawing of a cross-section of a conventional plano-convex Fresnel lens showing radiation incident from the Fresnel side of the lens.

FIG. 2 is a schematic drawing of a cross-section of a conventional plano-convex Fresnel lens showing radiation incident from the planar side of the lens.

FIG. 3A is a schematic drawing of a cross-section of an embodiment of a directed Fresnel lens in accordance with the present disclosure showing radiation incident from the Fresnel side of the lens.

FIG. 3B is a schematic top view of an embodiment of a directed Fresnel lens in accordance with the present disclosure showing the concentric grooves of the lens.

FIG. 4 is schematic drawing of a cross-section of an embodiment of a directed Fresnel lens in accordance with the present disclosure showing radiation incident from the planar side of the lens.

FIG. 5 is a schematic drawing of a cross-section of a symmetric embodiment of a directed Fresnel lens in accordance with the present disclosure showing radiation incident from the Fresnel side of the lens.

FIG. 6 is a schematic drawing of a cross-section of a symmetric embodiment of a directed Fresnel lens in accordance with the present disclosure showing radiation incident from the planar side of the lens.

FIG. 7 is a schematic drawing of an array of conventional and/or directed Fresnel lenses designed and configured to have an angular field of view much greater than that of a conventional Fresnel lens.

FIG. 8 is a schematic drawing of a mixed Fresnel lens in accordance with an alternative embodiment.

FIG. 9A is a schematic drawing of a directed Fresnel lens in accordance with one embodiment of this disclosure wherein the grooves are parallel and have planar symmetry.

FIG. 9B is a schematic drawing of a cross-section of the lens of FIG. 9A.

### DETAILED DESCRIPTION OF PREFERRED EMBODIMENTS

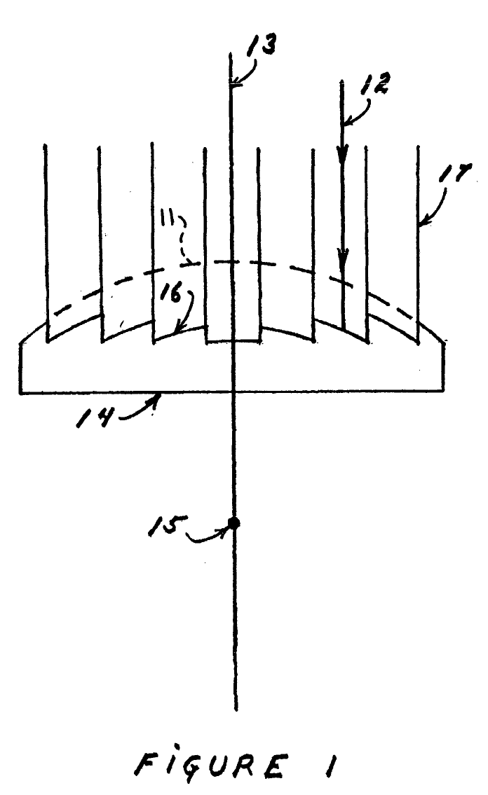

FIG. 1, described previously, is a schematic drawing of a cross-section of a conventional plano-convex Fresnel lens showing radiation 12 incident from the Fresnel side 16 of the lens.

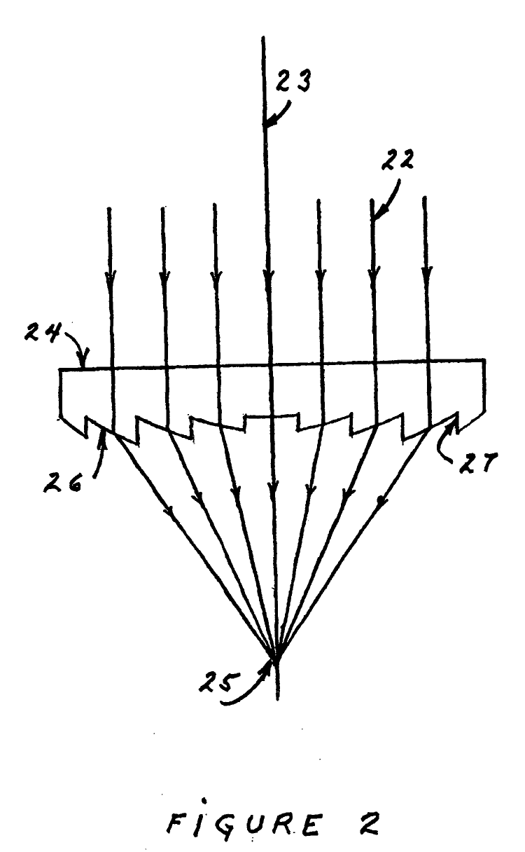

FIG. 2 is a schematic drawing of a conventional plano-convex Fresnel lens showing radiation 22 incident from the planar side 24 of the lens. The conceptual basis of this configuration is the same as that of the lens illustrated in FIG. 1 and previously discussed. Rays 22 parallel to the optic axis 23 incident from the planar side of the lens 24 are refracted at the Fresnel surface 26 and pass through the lower focal point 25. These concepts also explain the behavior of such lenses for any incident radiation field e.g. a system of rays emanating from a focal point, or any optical, infrared or other frequency scene.

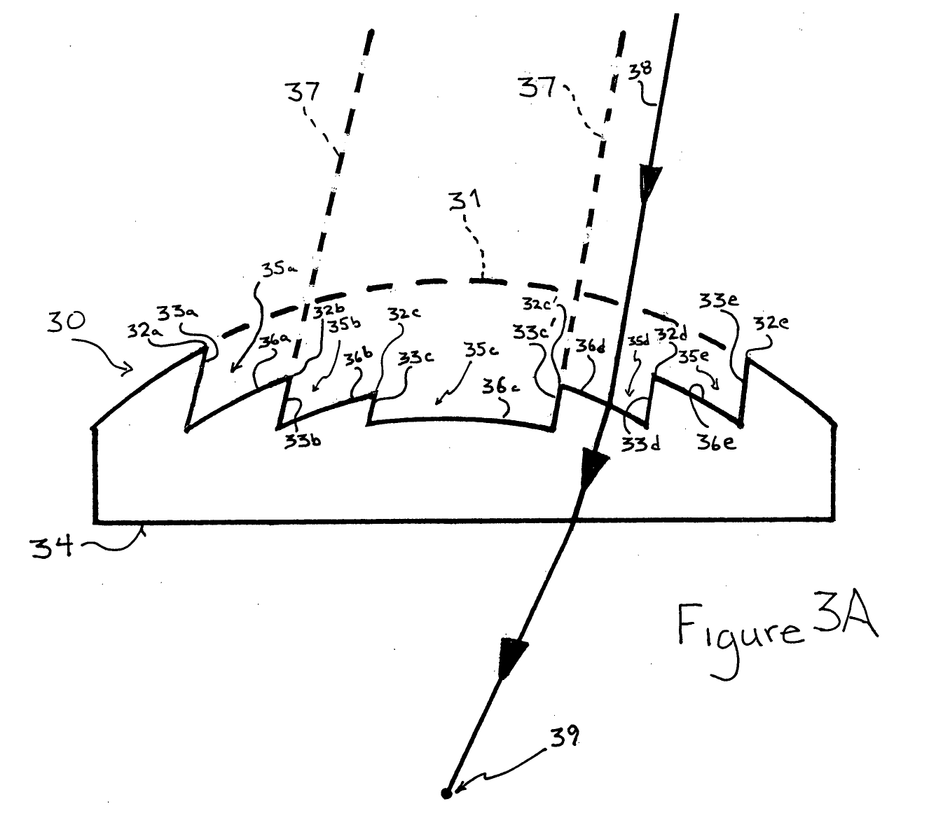

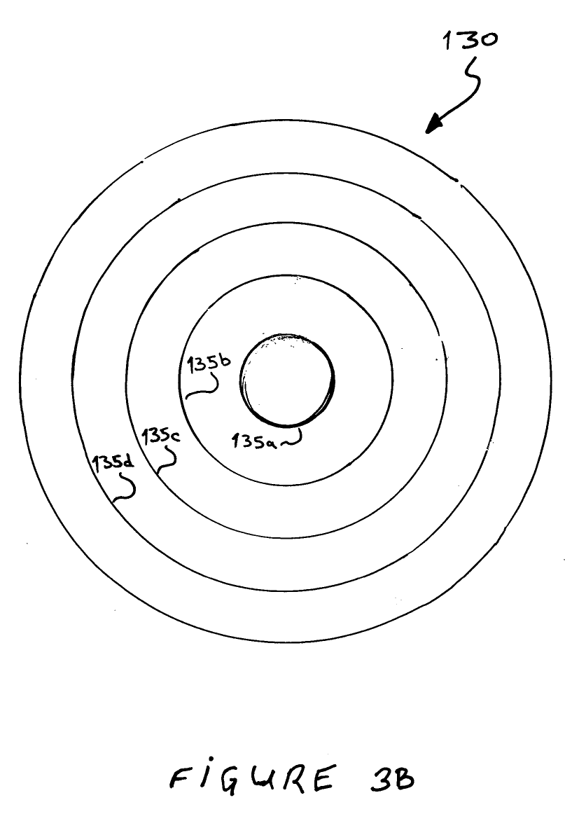

FIG. 3A is a schematic drawing of a cross-section of a new type of Fresnel lens 30 in accordance with the present disclosure referred to herein as a directed Fresnel lens. The system of lines 17 in FIG. 1 is replaced by the system of lines 37 in FIG. 3A which are not perpendicular to the plane 34. As seen in FIG. 1, when the segments are translated downward, a plurality of grooves 35a-35e are formed, each groove having at least one substantially straight side wall 33a-33e and a bottom 36a-36e. Note that groove 35c has two straight side walls 35c, 35c′. The top edges 32a-32e of grooves 35a-35e define a substantially planar surface. The surfaces of bottoms 36a-36e of displaced segments in FIG. 3A collectively provide desired optical characteristics by approximating the same shape and orientation as the corresponding segment of the original lens surface 31 (shown in phantom). In this and other embodiments, the bottoms of the grooves can be curved to match segments of the original lens surface, or, if the segments are small enough, can be straight and approximate of the original lens surface without a substantial loss of optical performance. The difference is that for the directed lens 30 of FIG. 3A the segments of the original lens surface 31 are translated parallel to the lines 37. Thus, the side wall 33a-33e of each segment is not perpendicular to planar surface 34, or to the substantially planar surface defined by top edges 32a-f of grooves 35a-f. An incident ray 38 parallel to the lines 37 is refracted at each of the surfaces 36a-33e and 34 to pass through the focal point 39. The behavior of this lens is different than that of the lens shown in FIG. 1 in that optimum performance is obtained for incident radiation in the direction of lines 37 which are not perpendicular to the surface 34. As with a conventional Fresnel lens, aberrations degrade the performance of the directed Fresnel lens disclosed herein at angles different than that of the direction indicated by the system of lines 37. The angular field of view of the conventional Fresnel lens shown in FIG. 1 and the angular field of view of the directed Fresnel lens shown in FIG. 3A are comparable. However, in FIG. 1 the angular field of view of the lens is centered on the direction perpendicular to the planar surface 14. In FIG. 3A the angular field of view of the lens surrounds the direction indicated by the system of lines 37. Note that it is possible but not necessary that all of the Fresnel lens segments form grooves 35a-35e have the same width or depth. Further the grooves 35a-35e in FIG. 3A may be spherical, aspheric, cylindrical, straight or any other shape necessary to obtain the desired optical performance. For a cylindrical system the lines 37 in FIG. 3A represent a system of planes which intersect the plane 34 in a system of straight lines. For a circular system the lines 37 in FIG. 3A represent a system of circular cylinders which intersect the plane 34 in a system of ellipses. In certain embodiments, the grooves 135a-d of a directed Fresnel lens 130 in accordance with this disclosure are concentric, as shown schematically in FIG. 3B.

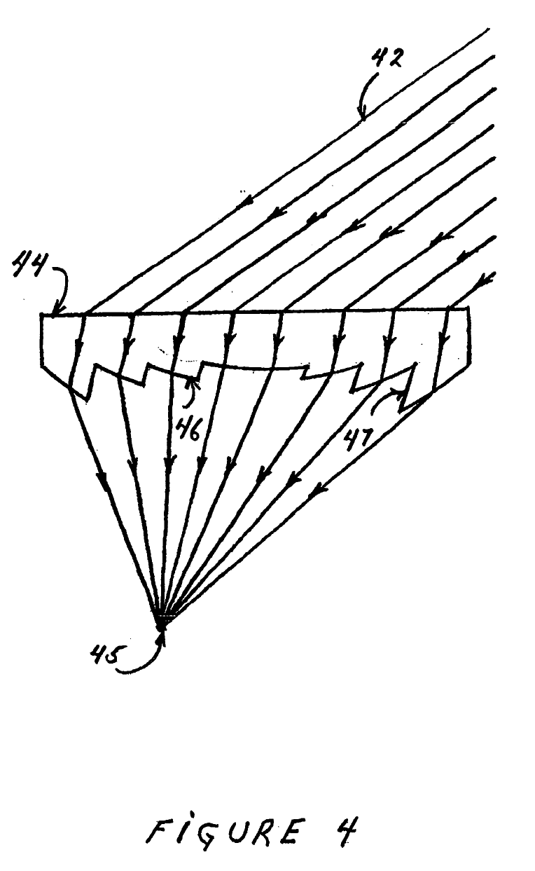

The directed lens shown in cross-section in FIG. 4 is similar to the directed lens shown in cross-section in FIG. 3A. The difference is that in FIG. 4 radiation 42 is incident from the planar side 44 of the lens. The conceptual basis of this configuration is the same as that of the lens illustrated in FIG. 3A. Notice that the incident rays 42 in FIG. 4 are shown at an angle such that on refraction at the upper surface 44 the refracted rays are parallel to the lines 47. The incident rays in the direction 42 define the direction about which the field of view of the lens is approximately centered. This theory also explains the behavior of such lenses for any incident optical, infrared or other frequency radiation field e.g. a system of rays emanating from a focal point or any scene.

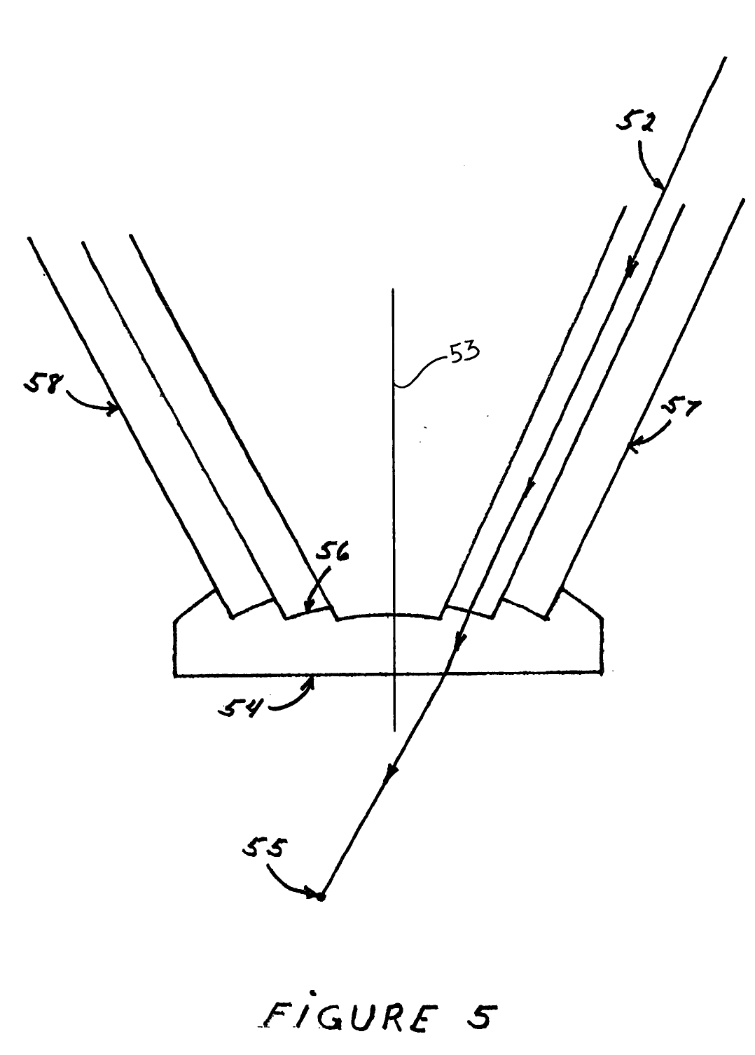

FIG. 5 is a schematic drawing of a cross-section of a symmetric plano-convex directed Fresnel lens with radiation incident from the Fresnel side 56 of the lens. For a lens with cylindrical symmetry the lines 57, 58 represent planes which intersect the plane 54 in straight lines. For a rotationally symmetric system the lines 57, 58 represent a conical surface which intersects the plane 54 in a circle. In a simple system each pair of lines 57, 58 defines a hollow cone of rays which pass through the focal point 55. The various cones defined by the various lens segments 56 may be oriented in different directions or all in the same direction. If the conical surfaces 57, 58 are all oriented parallel to each other i.e. have the same central axis as indicated in FIG. 5 the angular field of view of this directed Fresnel lens can be made to vary from that of a conventional Fresnel lens to much greater than that of a conventional Fresnel lens by increasing the angle between the lines 57, 58 and the central axis 53. For a sufficiently large angle between the lines 57, 58 and the central axis 53 the angular field of view of this lens is the angular region between two cones.

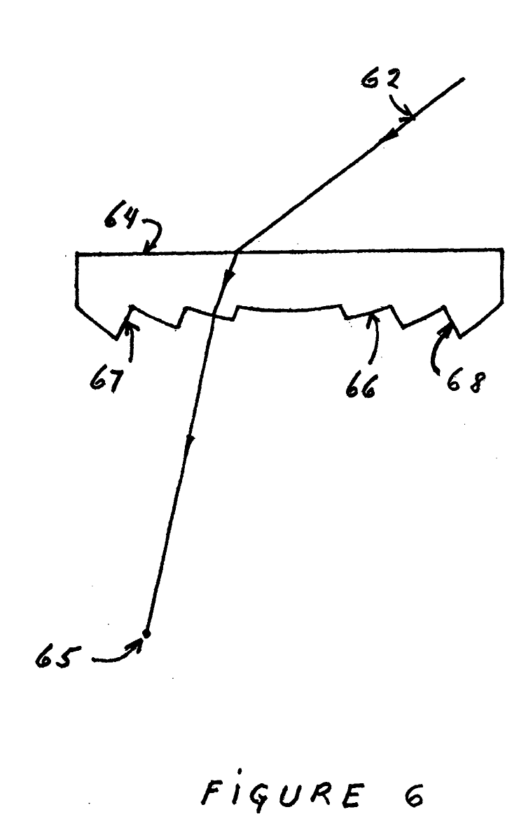

FIG. 6 is similar to FIG. 5 except that radiation 62 is incident from the planar side 64 of the lens. The direction of the rays 62 has been chosen so that on refraction at the upper planar surface 64 the direction of the ray inside of the lens is parallel to the line 67. This is the direction in which the lens has “ideal” performance. After refraction at the Fresnel surface 66 the ray passes through the focal point 65. The angular field of view of this lens is centered on the direction parallel to the ray 62 which after refraction is parallel to the line 67. For a rotationally symmetric lens the conical surface defined by the pairs of lines 67-68 intersects the plane 64 in a circle. For a cylindrical system the pairs of lines 67-68 intersect the plane 64 in a pair of straight lines. In general, directed Fresnel lenses of this type may have cylindrical symmetry, planar symmetry, rotational symmetry, a more complicated symmetry or no symmetry at all.

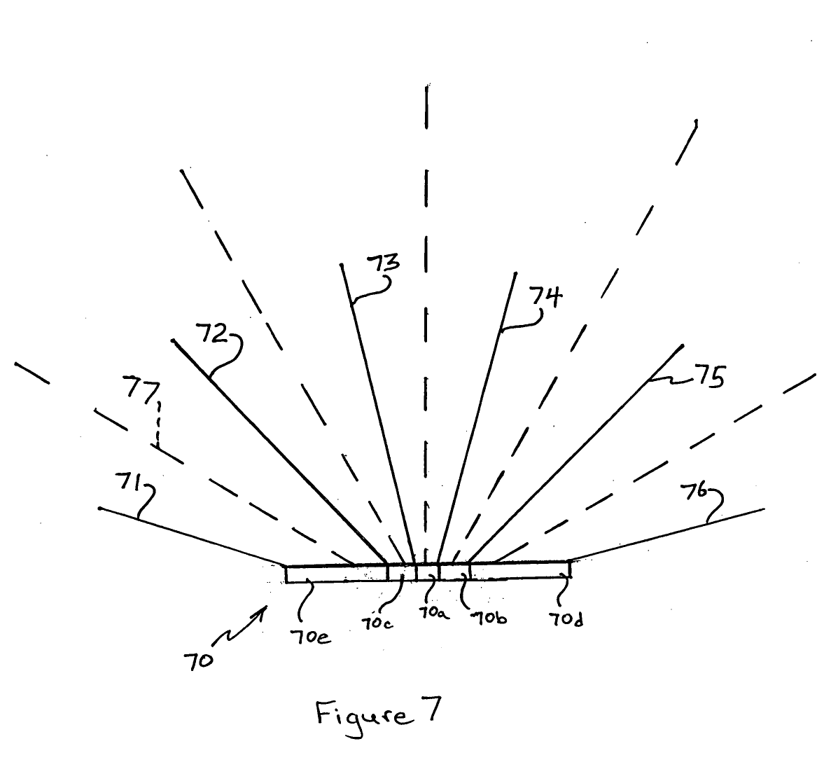

FIG. 7 is a schematic drawing of a flat, slightly curved, curved, linear or multi-linear array 70 of a conventional Fresnel Lens 70a and directed Fresnel lenses 70b, 70c, 70d, 70e designed and configured to have one focal spot for each element of the array 70 and a continuous collective angular field of view of the entire array 70 much greater than that of a single conventional Fresnel lens. FIG. 7 shows a five element array 70 where, for the purpose of illustration, it is assumed that each of the lens elements in the array 70 has the same angular field of view indicated by the angular ranges 71-72, 72-73, 73-74, 74-75, 75-76, and that the central direction of each of these angular fields of view is orientated parallel to the dashed lines 77 which divide the above angular ranges in half. In this configuration the collective angular field of view 71-76 of the entire array 70 is continuous and much greater than the angular field of view of a single lens in the array 70. If the angle between adjacent pairs of dashed rays 77, which define the centers of the angular fields of view of the individual lenses, is less than the angular field of view of a single one of the lenses in the array 70, the individual lens elements of the array 70 have overlapping fields of view. Conversely, if the angular separation of the dashed rays 77 is greater than the angular field of view of a single lens in the array 70 there will be gaps in the collective angular field of view of the entire lens array 70. In general the focal length, size and angular field of view of the individual lenses in the array 70 may not be the same. Flat, slightly curved or curved lens arrays of this type have application, for example, in motion detectors, intrusion detectors and occupancy sensors. A particularly useful configuration in these applications is an array of directed Fresnel lenses of the plano-convex type with radiation incident from the planar side of each lens in the array.

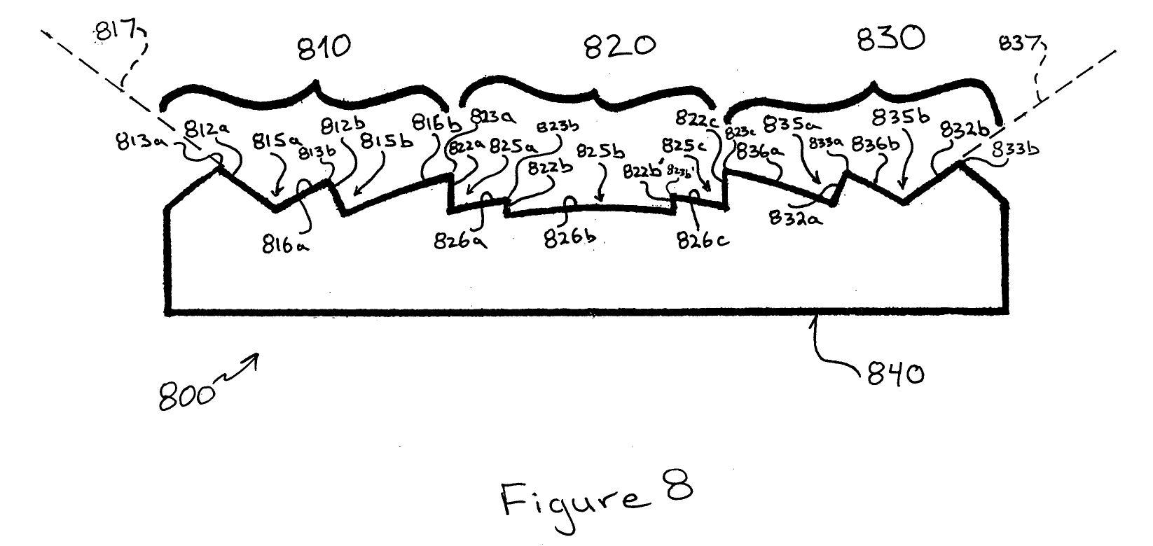

In another embodiment, Fresnel lenses in accordance with this disclosure are partly of the conventional type and partly of the directed type disclosed herein. Such lenses are referred to herein as “mixed Fresnel” lenses. In such a design, as seen in FIG. 8, part 820 of the lens 800 employs sectioning lines which, as in FIGS. 1 and 2 are parallel to the optic axis of the conventional part(s) of the system while the directed parts 810, 830 of the lens employ sectioning lines similar to those shown in FIGS. 3 and 4 which are at an angle to plane 840. More specifically, the grooves 815a and 815b of part 810 of lens 800 each include a straight side wall 812a, 812b and a bottom 816a, 816b. The straight side walls 812a, 812b are not perpendicular to plane 840. In part 820 of lens 800, the grooves 825a-825c include straight side walls 822a-822c and bottoms 826a-826c. Groove 825b actually has two straight sides 822b and 822b′. The straight sides 822a-822c are perpendicular to plane 840 as in a conventional Fresnel lens. The grooves 835a and 835b of part 830 of lens 800 each include a straight side 832a, 832b and a bottom 836a, 836b. The straight sides 832a, 832b are not perpendicular to plane 840. The straight sides 812a, b and 832a, b are all at different angles so that lens 800 has a wide angular field of view spanning from line 817 to line 837.

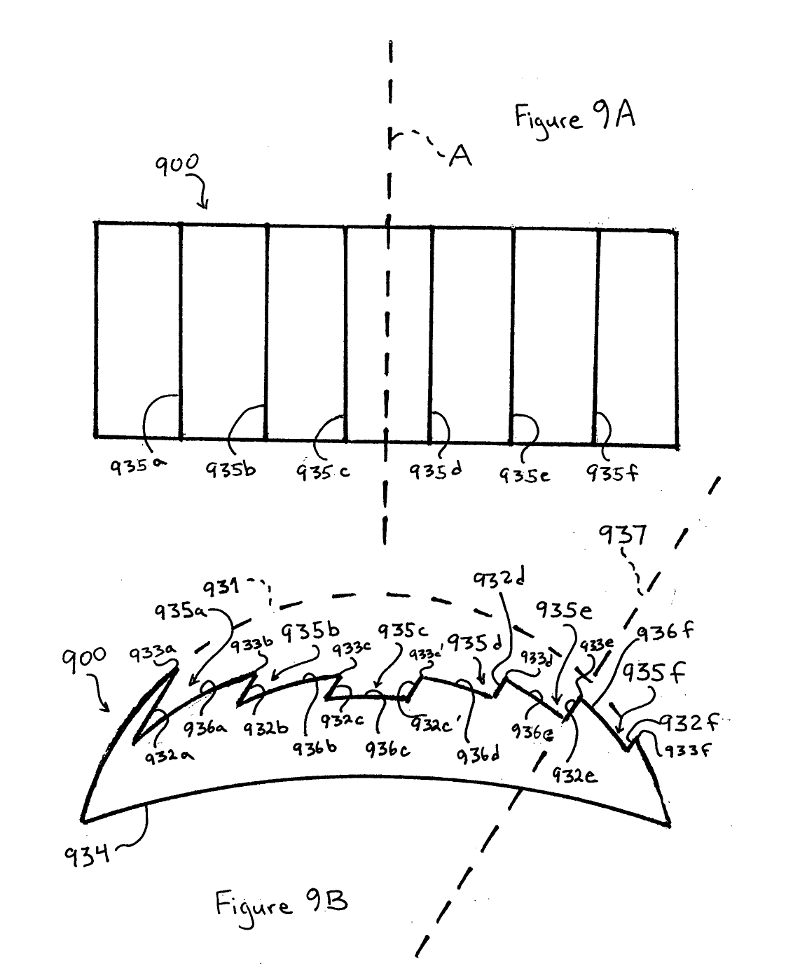

In FIG. 9A, a directed Fresnel lens 900 having parallel grooves 935a-935f is schematically shown. The grooves 935a-f are substantially straight, substantially parallel and exhibit planar symmetry around plane A. As seen in FIG. 9B, groove 935a includes a substantially straight side 932a and a bottom 936a. The other grooves 935b-f also include straight sides 932b-f and bottoms 936b-f. In this embodiment, the top edges 933a-933e of grooves 935a-935e define a curved surface. The bottoms 936a-f collectively approximate the curved surface 931 of a conventional convex lens. The sides 932a-f are oriented in the direction of line 937, askew to plane A and are not perpendicular to a line perpendicular to the direction of the grooves. In a conventional Fresnel lens, the segments would be translated in a direction parallel to plane A and perpendicular to a line perpendicular to the direction of the grooves. Bottom surface 934 of lens 900 is curved rather than planar (as shown illustratively in the other embodiments).

The procedures outlined above can be applied to design directed Fresnel lenses with circular symmetry, cylindrical symmetry or lenses without any symmetry at all. Directed Fresnel lenses can be designed by standard ray tracing techniques and can be fabricated out of conventional materials by methods currently in use to fabricate conventional Fresnel lenses. Micro-electro-mechanical (MEMS) fabrication techniques can also be used to fabricate the directed Fresnel lenses disclosed herein. In addition, the procedures outlined above can be applied to design directed Fresnel lenses based on single surface, biconvex, plano-convex, convex meniscus, biconcave, plano-concave, and concave meniscus lenses, combinations thereof or of lenses with arbitrary surface curvature and functionality. Further the slopes and shapes of the various Fresnel segments can be designed to reproduce the simple focusing action of a conventional lens or to provide more general processing of the incident radiation field. The directed Fresnel lenses disclosed herein can be used in any application to replace a lens, a compound lens, a segmented lens, or a lens array. Non-limiting examples are: motion detectors, intrusion detectors, occupancy sensors, solar concentrators, optical communication systems, optical coupling, integrated optics, overhead and rear projectors, displays, cameras, lighting systems, vehicle lamps, traffic signals, skylights, and wide angle windows.

It will be understood that various modifications may be made to the embodiments disclosed herein. For example, Fresnel lenses of the directed or mixed type can be designed with a quasi-continuous variation of the angular orientation of the directionality of system that is, each Fresnel segment may be defined by sectioning lines of different direction. As another example, the lens can be designed to have grooves on both sides, where at least one side constitutes a directed Fresnel lens in accordance with this disclosure. Therefore, the above description should not be construed as limiting, but merely as exemplifications of preferred embodiments. Those skilled in art will envision other modifications within the scope and spirit of the above discussion.

1. A directed Fresnel lens.

2. A lens comprising
a plurality of grooves,
each groove having a top edge, at least one side and a bottom,
the top edges of the plurality of grooves defining a substantially planar surface,
the bottoms of the plurality of grooves collectively approximating a surface having desired optical characteristics;
at least one side of one of the plurality of grooves being non-perpendicular to the substantially planar surface defined by the top edges of the plurality of grooves.

3. A lens as in claim 2 further comprising a second substantially planar surface.

4. A lens as in claim 2 further comprising a second curved surface.

5. A lens as in claim 2 wherein the grooves are substantially concentric circles.

6. A lens as in claim 2 wherein the grooves are symmetrical about an axis of rotation.

7. A lens as in claim 6 wherein at least one side of at least one of the plurality of grooves is not parallel to the axis of rotation.

8. A lens as in claim 2 wherein the grooves are straight.

9. A lens as in claim 2 wherein the grooves are parallel to each other.

10. A lens as in claim 9 wherein at least one side of at least one of the plurality of grooves is not perpendicular to a line perpendicular to the direction of the grooves.

11. A lens comprising
a plurality of grooves,
each groove having a top edge, at least one side and a bottom,
the top edges of the plurality of grooves defining a curved surface,
the bottoms of the plurality of grooves collectively approximating a surface having desired optical characteristics;
at least one side of one of the plurality of grooves being non-perpendicular to the curved surface defined by the top edges of the plurality of grooves.

12. A lens as in claim 11 further comprising a second substantially planar surface.

13. A lens as in claim 11 further comprising a second curved surface.

14. A lens as in claim 11 wherein the grooves are substantially concentric circles.

15. A lens as in claim 11 wherein the grooves are symmetrical about an axis of rotation.

16. A lens as in claim 15 wherein at least one side of at least one of the plurality of grooves is not parallel to the axis of rotation.

17. A lens as in claim 11 wherein the grooves are straight.

18. A lens as in claim 11 wherein the grooves are parallel to each other.

19. A lens as in claim 18 wherein at least one side of at least one of the plurality of grooves is not perpendicular to a line perpendicular to the direction of the grooves.

20. A lens comprising
a plurality of grooves that are symmetrical about an axis of rotation,
each groove having at least one substantially straight side and a bottom,
the bottoms of the plurality of grooves collectively approximating a surface having desired optical characteristics;
at least one side of one of the plurality of grooves being non-parallel to the axis of rotation.

21. A lens as in claim 20 further comprising a second substantially planar surface.

22. A lens as in claim 20 further comprising a second curved surface.

23. A lens as in claim 20 wherein the grooves are substantially concentric circles.

24. A lens comprising
a plurality of grooves,
each groove having a top edge, at least one side and a bottom,
the top edges of the plurality of grooves being straight and parallel,
the bottoms of the plurality of grooves collectively approximating a surface having desired optical characteristics;
at least one side of one of the plurality of grooves being non-perpendicular to a line perpendicular to the top edges of the plurality of grooves.

25. A lens as in claim 24 further comprising a second substantially planar surface.

26. A lens as in claim 24 further comprising a second curved surface.

27. A lens comprising a plurality of grooves, each groove having at least one substantially planar side and a bottom, the substantially planar sides of at least two of the plurality of grooves being non-parallel to each other.

28. A lens array comprising at least one directed Fresnel lens.

29. A lens array comprising a lens in accordance with claim 2.

30. A lens array comprising a lens in accordance with claim 11.

31. A lens array comprising a lens in accordance with claim 20.

32. A lens array comprising a lens in accordance with claim 24.

33. A lens array comprising a lens in accordance with claim 27.

34. A lens comprising
a plurality of grooves,
each groove having a top edge, at least one side and a bottom,
the top edges of the plurality of grooves defining a substantially planar surface,
the bottoms of the plurality of grooves collectively approximating a surface having desired optical characteristics;
at least one side of one of the plurality of grooves being non-perpendicular to the substantially planar surface defined by the top edges of the plurality of grooves,
wherein the lens exhibits the optical characteristics of a lens type selected from the group consisting of biconvex, plano-convex, convex meniscus, biconcave, plano-concave, concave meniscus lens, arbitrary surface curvature and combinations thereof.
